(19) United States
(12) Patent Application Publication
(10) Pub. No.: US 2022/0292813 A1
(43) Pub. Date: Sep. 15, 2022

(54) SYSTEMS AND METHODS FOR DETECTING OBJECTS AN IMAGE USING A NEURAL NETWORK TRAINED BY AN IMBALANCED DATASET

(71) Applicant: Acronis International GmbH, Schaffhausen (CH)

(72) Inventors: Sergey Ulasen, Moscow (RU); Vasyl SHANDYBA, Dnipro (UA); Alexander SNORKIN, Moscow (RU); Artem SHAPIRO, Dnipro (UA); Andrey ADASCHIK, Moscow (RU); Serguei Beloussov, Costa Del Sol (SG); Stanislav PROTASOV, Singapore (SG)

(21) Appl. No.: 17/681,784

(22) Filed: Feb. 27, 2022

Related U.S. Application Data
(60) Provisional application No. 63/159,249, filed on Mar. 10, 2021.

(51) Int. Cl. G06V 10/774; G06V 10/764; G06V 10/82; G06V 10/776; G06V 20/40; G06N 3/04

(52) U.S. Cl. CPC G06V 10/774; G06V 10/764; G06V 10/82; G06V 10/776; G06V 20/42; G06N 3/04

(57) ABSTRACT

Disclosed herein are systems and method for classifying objects in an image using a neural network. In one exemplary aspect, the techniques described herein relate to a method including: training, with a dataset including a plurality of images, a neural network to identify objects of a set of classes, wherein the neural network includes: a shared convolutional backbone with feature extraction layers, and a plurality of heads with fully connected layers, wherein there is a respective distinct head for each of the set of classes; receiving an input image depicting at least one object from the set of classes; inputting the input image into the neural network, wherein the neural network is configured to classify the at least one object into at least one class of the set of classes; and outputting the at least one class.

### CROSS-REFERENCE TO RELATED APPLICATIONS

This application claims the benefit of U.S. Provisional Application No. 63/159,249, filed Mar. 10, 2021, which is herein incorporated by reference.

### FIELD OF TECHNOLOGY

The present disclosure relates to the field of computer vision, and, more specifically, to systems and methods for detecting objects an image using a neural network trained by an imbalanced dataset.

### BACKGROUND

The quality of a training dataset often dictates whether an image classification neural network will effectively detect objects in images. A good-quality training dataset will ideally have an abundance of images that clearly depict and properly label the objects to be detected. However, even if all objects are properly labelled and visible, class imbalance can prevent effective training. For example, if there are too many examples of one class of objects relative to other the classes, the neural network may develop a bias that favors classification of the class with more examples. In some cases, this can be controlled by having an equal number of examples for each class. This solution, however, is not applicable in all scenarios. Consider a training dataset that includes images of a soccer match taken from a broadcast view. The two classes to detect may be “player,” and “ball,” and each occurrence of a ball or player may be highlighted in the training images by a bounded box. Given that there are multiple players and only one ball in each image, there is a non-trivial imbalance between the two classes.

In this case, it is quite difficult to train one object detection neural networks for two classes, and typically two separate neural networks are trained. However, two neural networks require more than two times the computation resources. Even when trained, if the neural networks are used for a livestream (e.g., a soccer match), the video processing will be more than two times slower—preventing real-time analysis. Thus, there exists a need for training a single neural network with an imbalanced dataset.

### SUMMARY

In one exemplary aspect, the techniques described herein relate to a method for classifying objects in an image using a neural network, the method including: training, with a dataset including a plurality of images, a neural network to identify objects of a set of classes, wherein the neural network includes: a shared convolutional backbone with feature extraction layers, and a plurality of heads with fully connected layers, wherein there is a respective distinct head for each of the set of classes; receiving an input image depicting at least one object from the set of classes; inputting the input image into the neural network, wherein the neural network is configured to classify the at least one object into at least one class of the set of classes; and outputting the at least one class.

In some aspects, the techniques described herein relate to a method, wherein the neural network is further trained to determine locations of the objects of the set of classes.

In some aspects, the techniques described herein relate to a method, wherein each of the plurality of heads includes a regression sub-head for determining a respective location of a given class object and a classification sub-head for determining a class score of the given class object.

In some aspects, the techniques described herein relate to a method, wherein the dataset is an imbalanced dataset including a threshold number more examples of a first class of objects than a second class of objects.

In some aspects, the techniques described herein relate to a method, wherein the neural network is further configured to determine a respective class loss for the respective distinct head.

In some aspects, the techniques described herein relate to a method, wherein the neural network is further configured to determine a total loss across the set of classes, wherein the total loss is a linear combination of each respective class loss.

In some aspects, the techniques described herein relate to a method, wherein the input image is a video frame of a livestream, and wherein the neural network classifies the at least one object in real-time.

In some aspects, the techniques described herein relate to a method, wherein the set of classes includes a first class for a game ball and a second class for an athlete.

It should be noted that the methods described above may be implemented in a system comprising a hardware processor. Alternatively, the methods may be implemented using computer executable instructions of a non-transitory computer readable medium.

In some aspects, the techniques described herein relate to a system for classifying objects in an image using a neural network, the system including: a memory; and a hardware processor communicatively coupled with the memory and configured to: train, with a dataset including a plurality of images, a neural network to identify objects of a set of classes, wherein the neural network includes: a shared convolutional backbone with feature extraction layers, and a plurality of heads with fully connected layers, wherein there is a respective distinct head for each of the set of classes; receive an input image depicting at least one object from the set of classes; input the input image into the neural network, wherein the neural network is configured to classify the at least one object into at least one class of the set of classes; and output the at least one class.

In some aspects, the techniques described herein relate to a non-transitory computer readable medium storing thereon computer executable instructions for classifying objects in an image using a neural network, including instructions for: training, with a dataset including a plurality of images, a neural network to identify objects of a set of classes, wherein the neural network includes: a shared convolutional backbone with feature extraction layers, and a plurality of heads with fully connected layers, wherein there is a respective distinct head for each of the set of classes; receiving an input image depicting at least one object from the set of classes; inputting the input image into the neural network, wherein the neural network is configured to classify the at least one object into at least one class of the set of classes; and output the at least one class.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for detecting objects an image using a neural network trained by an imbalanced dataset.

FIG. 2 is a block diagram illustrating an exemplary neural network structure.

FIG. 3 illustrates a flow diagram of a method for detecting objects an image using a neural network trained by an imbalanced dataset.

FIG. 4 presents an example of a general-purpose computer system on which aspects of the present disclosure can be implemented.

### DETAILED DESCRIPTION

Exemplary aspects are described herein in the context of a system, method, and computer program product for detecting objects an image using a neural network trained by an imbalanced dataset. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

In order to address the shortcomings described in the background section of the present disclosure, systems and methods are presented for object detection using a neural network trained by an imbalanced dataset. The slowest part of each object detector is a convolutional neural network backbone that provides features for classification and regression heads. Since the imbalance problem is crucial for heads, the present disclosure describes training a single shared convolutional neural network backbone for multi-class detection, while leaving the heads as if they were different networks. In some aspects, the shared loss will be a linear combination of the multi-class losses.

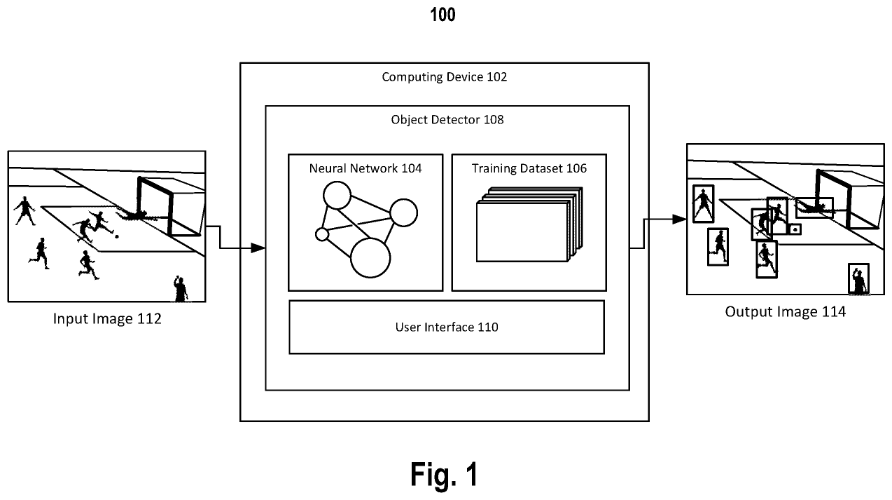

FIG. 1 is a block diagram illustrating system 100 for detecting objects an image using a neural network trained by an imbalanced dataset. In an exemplary aspect, system 100 includes computing device 102 that stores neural network 104 and training dataset 106 in memory. Neural network 104 may be an image classifier that identifies an object in an image and outputs a label. Neural network 104 may also be an image classifier that identifies an object in an image and generates a boundary around the object.

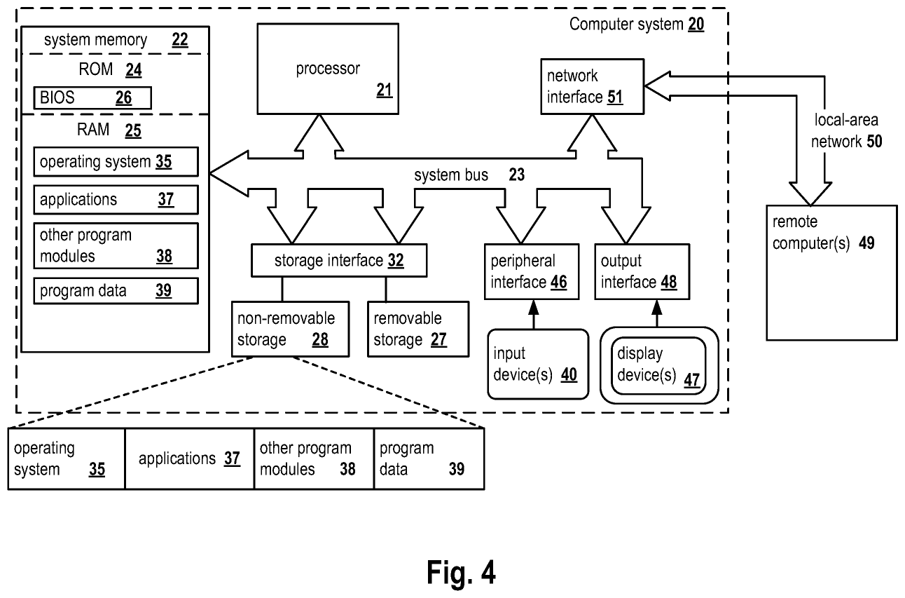

Object detector 108 is a software module that comprises neural network 104, training dataset 106, and user interface 110. User interface 110 accepts an input image 112 and provides output image 114. In some aspects, neural network 104 and training dataset 106 may be stored on a different device than computing device 102. Computing device 102 may be a computer system (described in FIG. 4) such as a laptop. If neural network 104 and/or training dataset 106 are stored on a different device (e.g., a server), computing device 102 may communicate with the different device to acquire information about the structure of neural network 104, code of neural network 104, images in training dataset 106, etc. This communication may take place over a network (e.g., the Internet). For example, object detector 108 may be split into a thin client application and a thick client application. A user may provide input image 112 via user interface 110 on computing device 102. This interface 110, in this case, is part of the thin client. Subsequently, input image 112 may be sent to the different device comprising the thick client with neural network 104 and training dataset 106. Neural network 104 may yield output image 114 and transmit it to computing device 102 for output via user interface 110.

Consider an example in which input image 112 is a frame of a real-time video stream depicting multiple objects. This video steam may be of a soccer match and the multiple objects may include a soccer ball and humans (e.g., players, coaches, staff, fans, etc.). As shown in FIG. 1, the image may be a far-view of the soccer field (e.g., a broadcast view). Training dataset 106 may include a plurality of images, each depicting multiple objects. In some aspects, there may be an imbalance of the type of objects in each training image. For example, training dataset 106 may include between 10-60 times more players than balls and have 4 times the amount of anchors for players than for balls. Thus, the imbalance between players and balls is approximately 40-240:1. In one approach, this imbalance can be handled in loss using weights. For example, the loss of a ball can be multiplied by 40, but even then the ball confidence output by the neural network will be very low with several false positives. In addition, this may cause player detection to get worse, while not improving ball detection. Thus, this approach is ineffective.

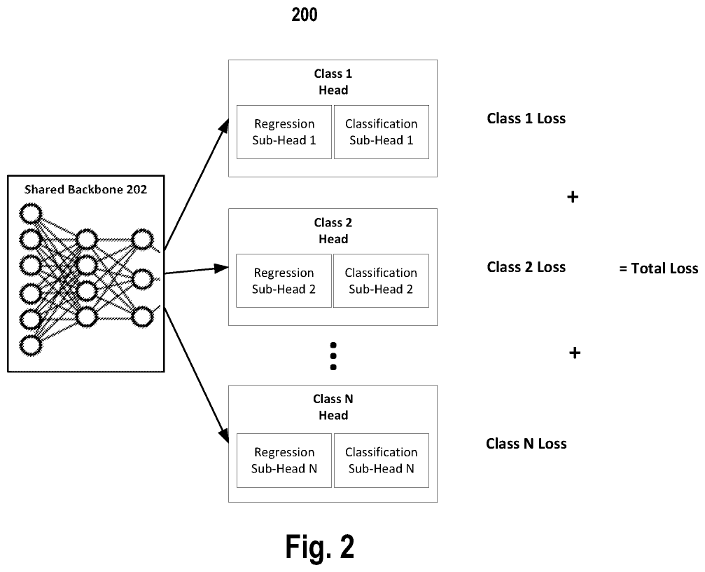

FIG. 2 is a block diagram illustrating an exemplary neural network structure 200 (e.g., of neural network 104). Structure 200 comprises a shared neural network backbone 202. Backbone 202 includes the feature extraction layers that receive an input image (e.g., image 202) and generate feature maps containing high-level information. Example feature extraction layers may be convolutional and pooling layers.

In order to properly address the imbalance issue, the present disclosure implements multiple heads. More specifically, each class gets its own head comprising at least one fully connected layer. For example, in reference to FIG. 1, there may be pair of heads for both ball and player classes. Neural network 104 may calculate loss for each class independently, and combine the losses as a linear/weighted sum at the end. Unlike a conventional multi-head neural network where there is a regression head and a classification head for all classes (i.e., a total of two heads), the present disclosure describes a head for each class. In other words, the object detector does not simply train with two heads (regression+classification) for all classes at the same time. In some aspects, class 1 head may comprise regression and classification sub-heads, class 2 head may comprise a different regression sub-head and a different classification sub-head, and class N may comprise yet another different regression sub-head and classification sub-head.

For example, class 1 may be a “player” class. The classification sub-head may generate class scores (i.e., whether a player is detected or not), and the regression sub-head may generate box coordinates (i.e., where the player is located). Likewise, class 2 may be a “ball” class. The classification sub-head may generate class scores (i.e., whether a ball is detected or not), and the regression sub-head may generate box coordinates (i.e., where the ball is located). As mentioned before, because there are multiple players compared to a ball in any given example, a neural network with a single head may be unable to effectively distinguish between the two classes. If two different neural networks are used, the amount of processing is doubled for each input image. Accordingly, neural network structure 300 enables more accurate classifications than a single-head neural network, without requiring as much processing as running two neural networks.

In some aspects, training neural network 104 may include updating a plurality of weights for each of the layers in neural network 104. In particular, the weights associated with each head/sub-head are randomly initialized to prevent the same weights in each of the heads after training. As each head has its own set of weights, the way the neural network handles an input image is different than a single head neural network. For example, shared backbone 202 (e.g., convolution, pooling, etc.) extracts a feature map from input image 112. The feature map includes high-level summarized information. Each head of neural network 104 then uses this feature map to detect an object of its class and, in some aspects, coordinates of the object in the input image. Depending on the accuracy of the detection, a class loss is determined for each head. In some aspects, the total loss is a linear/weighted sum of the individual class losses for each prediction head.

The total loss is then optimized. It should be noted that when the total loss is optimized, the weights for each head are adjusted without one class or the other experiencing overfitting (i.e., the neural network has to be just as accurate in identifying a ball as it is identifying a player). In a single-headed neural network, if the neural network identifies players with high accuracy, but is unable to identify balls as accurately, because there are more examples of players, the total loss will remain low. In this case, the loss associated with the second class (balls) may be equal in weight or may be higher in weight than the first class (players), which prevents the total loss from being influenced or saturated by player examples. In some aspects, the weight of each class in the weighted sum for total class is proportional to the average amount of examples found in an input image. For example, if there are five times as many examples of players than balls, the weight applied to class 1 loss may be 1 and the weight applied to class 2 loss may be 1.20 (i.e., 1+⅕).

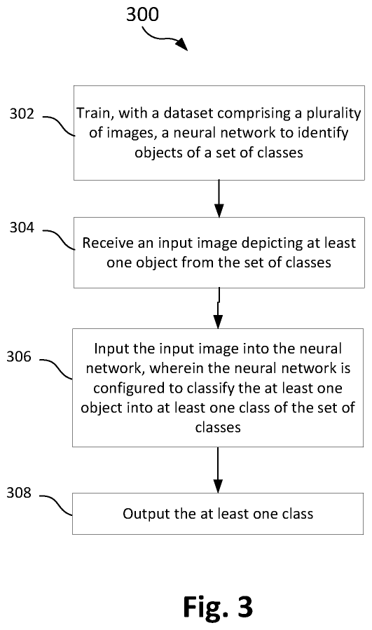

FIG. 3 illustrates a flow diagram of method 300 for detecting objects an image using a neural network trained by an imbalanced dataset. At 302, object detector 108 trains, with a dataset comprising a plurality of images (e.g., training dataset 106), a neural network (e.g., neural network 104) to identify objects of a set of classes. In an exemplary aspects, the neural network is made up of a shared convolutional backbone with feature extraction layers (e.g., backbone 202) and a plurality of heads with fully connected layers (e.g., class 1 head, class 2 head, . . . , class N head), wherein there is a respective distinct head for each of the set of classes.

When classifying objects, the neural network is further configured to determine a respective class loss for the respective distinct head (e.g., class 1 loss, class 2 loss, . . . , class N loss). In some aspects, the neural network determines a total loss across the set of classes as a linear combination of each respective class loss.

In some aspects, the dataset is an imbalanced dataset comprising a threshold number more examples of a first class of objects than a second class of objects. For example, the set of classes may consist of a first class for a game ball and a second class for an athlete. There may be 100 more examples of an athlete than a game ball.

At 304, object detector 108 receives an input image (e.g., input image 112) depicting at least one object from the set of classes (e.g., via user interface 110). At 306, object detector 108 inputs the input image into the neural network, wherein the neural network is configured to classify the at least one object into at least one class of the set of classes.

In some aspects, the neural network is further trained to determine locations of the objects of the set of classes (e.g., as highlighted by boxes surrounding the objects in output image 114). In this case, each of the plurality of heads comprises a regression sub-head for determining a respective location of a given class object (e.g., regression sub-head 1, 2, . . . N) and a classification sub-head for determining a class score of the given class object (e.g., classification sub-head 1, 2, . . . , N).

At 308, object detector 108 outputs the at least one class (e.g., user interface 110). For example, object detector 108 may generate, for display, output image 114 highlighting each detected object on computing device 102. Because there is only a single shared backbone in the neural network and feature extraction takes the longest processing time for any neural network, the disclosed neural network classifies the at least one object in real-time. For example, the input image may be a video frame of a livestream and the object detector 108 may generate output images with classified objects in real-time (i.e., minimal latency between input and output streams).

Subsequent to outputting the at least one class, object detector 108 may transmit the class and coordinate information to a content distributor. For example, the input image may be part of a stream from the content distributor (e.g., a sports channel) that is provided to object detector 108. Object detector 108 may generate an output image for each input image received and transmit the output image to the content distributor so that they may display the classified image to a particular audience (e.g., the sports team, the general public, etc.).

FIG. 4 is a block diagram illustrating a computer system 20 on which aspects of systems and methods for detecting objects an image using a neural network trained by an imbalanced dataset may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-4 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for classifying objects in an image using a neural network, the method comprising:
training, with a dataset comprising a plurality of images, a neural network to identify objects of a set of classes, wherein the neural network comprises:
a shared convolutional backbone with feature extraction layers, and
a plurality of heads with fully connected layers, wherein there is a respective distinct head for each of the set of classes;
receiving an input image depicting at least one object from the set of classes;
inputting the input image into the neural network, wherein the neural network is configured to classify the at least one object into at least one class of the set of classes; and
outputting the at least one class.

2. The method of claim 1, wherein the neural network is further trained to determine locations of the objects of the set of classes.

3. The method of claim 2, wherein each of the plurality of heads comprises a regression sub-head for determining a respective location of a given class object and a classification sub-head for determining a class score of the given class object.

4. The method of claim 1, wherein the dataset is an imbalanced dataset comprising a threshold number more examples of a first class of objects than a second class of objects.

5. The method of claim 1, wherein the neural network is further configured to determine a respective class loss for the respective distinct head.

6. The method of claim 5, wherein the neural network is further configured to determine a total loss across the set of classes, wherein the total loss is a linear combination of each respective class loss.

7. The method of claim 1, wherein the input image is a video frame of a livestream, and wherein the neural network classifies the at least one object in real-time.

8. The method of claim 1, wherein the set of classes comprises a first class for a game ball and a second class for an athlete.

9. A system for classifying objects in an image using a neural network, the system comprising:
a memory; and
a hardware processor communicatively coupled with the memory and configured to:
train, with a dataset comprising a plurality of images, a neural network to identify objects of a set of classes, wherein the neural network comprises:
a shared convolutional backbone with feature extraction layers, and
a plurality of heads with fully connected layers, wherein there is a respective distinct head for each of the set of classes;
receive an input image depicting at least one object from the set of classes;
input the input image into the neural network, wherein the neural network is configured to classify the at least one object into at least one class of the set of classes; and
output the at least one class.

10. The system of claim 9, wherein the neural network is further trained to determine locations of the objects of the set of classes.

11. The system of claim 10, wherein each of the plurality of heads comprises a regression sub-head for determining a respective location of a given class object and a classification sub-head for determining a class score of the given class object.

12. The system of claim 9, wherein the dataset is an imbalanced dataset comprising a threshold number more examples of a first class of objects than a second class of objects.

13. The system of claim 9, wherein the neural network is further configured to determine a respective class loss for the respective distinct head.

14. The system of claim 13, wherein the neural network is further configured to determine a total loss across the set of classes, wherein the total loss is a linear combination of each respective class loss.

15. The system of claim 9, wherein the input image is a video frame of a livestream, and wherein the neural network classifies the at least one object in real-time.

16. The system of claim 9, wherein the set of classes comprises a first class for a game ball and a second class for an athlete.

17. A non-transitory computer readable medium storing thereon computer executable instructions for classifying objects in an image using a neural network, including instructions for:
training, with a dataset comprising a plurality of images, a neural network to identify objects of a set of classes, wherein the neural network comprises:
a shared convolutional backbone with feature extraction layers, and
a plurality of heads with fully connected layers, wherein there is a respective distinct head for each of the set of classes;
receiving an input image depicting at least one object from the set of classes;
inputting the input image into the neural network, wherein the neural network is configured to classify the at least one object into at least one class of the set of classes; and
output the at least one class.

18. The non-transitory computer readable medium of claim 17, wherein the neural network is further trained to determine locations of the objects of the set of classes.

19. The non-transitory computer readable medium of claim 18, wherein each of the plurality of heads comprises a regression sub-head for determining a respective location of a given class object and a classification sub-head for determining a class score of the given class object.

20. The non-transitory computer readable medium of claim 17, wherein the dataset is an imbalanced dataset comprising a threshold number more examples of a first class of objects than a second class of objects.
